(19) United States
(12) Patent Application Publication
(10) Pub. No.: US 2020/0341348 A1
(43) Pub. Date: Oct. 29, 2020

(54) CAMERA

(71) Applicant: Nidec Copal Corporation, Tokyo (JP)

(72) Inventors: Kenzo Imai, Tokyo (JP); Nobuaki Watanabe, Tokyo (JP); Yusuke Ehara, Tokyo (JP)

(21) Appl. No.: 16/856,030

(22) Filed: Apr. 23, 2020

(30) Foreign Application Priority Data
Apr. 25, 2019 (JP) 2019-083840

(51) Int. Cl. G03B 11/00; H04N 5/225

(52) U.S. Cl. CPC G03B 11/00; H04N 5/2254; H04N 5/2253

(57) ABSTRACT

A technique lowers the likelihood that a privacy-related image leaks through a network from a camera for capturing images of an individual or a private space, and enables a subject person to notice that privacy is protected. A camera includes an imaging optical system that captures an image of a subject, an image sensor, a blade that advances into an optical axis of the imaging optical system, and a blade driver that causes the blade to advance into and retract from the optical axis. The blade causes privacy-related information about a subject to be less recognizable.

### BACKGROUND

### Technical Field

The present invention relates to a camera having, for example, a privacy protection function.

### Description of the Background

Cameras such as outdoor and indoor surveillance cameras, cameras for monitoring the elderly living alone or pets kept indoors, and cameras incorporated in personal computers (PCs) and smartphones capture privacy-related images including the faces of individuals and interior appearance.

Such cameras, when connected to a network, may cause leakage of privacy-related images and have thus been improved for privacy protection. For example, some cameras convert a captured image into a digital image signal, process, or, for example, mosaic an entire converted digital image to abstract the image, and output the image (refer to Patent Literature 1 below).

### CITATION LIST

### Patent Literature

Patent Literature 1: Japanese Unexamined Patent Application Publication No. 2014-216828

### BRIEF SUMMARY

The technique described above abstracts (mosaics) an entire image to be output for checking of movement or a rough state of a subject person or object while protecting the privacy of the person. However, when connected to a network, this type of camera transmits image data and allows control of the operation of the camera through the network. This may cause leakage of a privacy-related image yet to be abstracted through the network due to, for example, malicious hacking.

The technique described above does not allow a subject person to directly notice that privacy is protected by image processing in the camera. The person may constantly worry that the camera may capture privacy-related images.

In response to the above issue, one or more aspects of the present invention are directed to a technique for lowering the likelihood that a privacy-related image leaks through a network from a camera for capturing images of an individual or a private space, and for enabling a subject person to directly notice that privacy is protected and eliminating worry.

The device according to one or more aspects of the present invention has the structure described below. A camera includes an imaging optical system that captures an image of a subject, an image sensor, a blade that advances into an optical axis of the imaging optical system, and a blade driver that causes the blade to advance into and retract from the optical axis. The blade causes privacy-related information about a subject to be less recognizable.

### BRIEF DESCRIPTION OF DRAWINGS

FIG. 1 is a schematic diagram of a camera according to an embodiment of the present invention.

FIG. 2 is a schematic diagram of a camera according to another embodiment of the present invention.

FIG. 3 is an exploded perspective view of a blade driver showing an example structure.

FIG. 4 is an exploded perspective view of the blade driver showing another example structure.

FIG. 5 is an exploded perspective view of the blade driver showing still another example structure.

FIG. 6 is an exploded perspective view of the blade driver showing still another example structure.

FIG. 7A is a diagram of a light shield with a mosaic, FIG. 7B is a diagram of a light shield with a mesh, and FIG. 7C is a diagram of a light shield with a concentric circle pattern, each showing an example structure of a blade.

FIG. 8A is a diagram showing an example structure of the blade with a star-shaped mark, and FIG. 8B is a diagram showing another example structure of the blade with characters.

FIG. 9A is an external view of an electronic device including a camera according to one embodiment of the present invention with the camera facing a user, and FIG. 9B is an external view of the electronic device with the camera facing rearward.

FIG. 10 is a schematic diagram of an example structure of the camera shown in FIGS. 9A and 9B.

FIG. 11 is a schematic diagram of another example of an electronic device.

FIG. 12A is a schematic diagram of a camera mounted on a substrate inside an electronic device, and FIG. 12B is a schematic diagram of a camera mounted on a front panel inside the electronic device.

FIG. 13A is a plan view of a camera placed inside an electronic device, and FIG. 13B is a side view of the camera.

FIG. 14 is a schematic diagram of a camera placed inside an electronic device.

FIG. 15A is a schematic diagram of a camera placed inside an electronic device and being used as a rear-facing camera, and FIG. 15B is a schematic diagram of a camera being used as a front-facing camera.

FIG. 16A is a schematic diagram of a camera placed in an electronic device and being used as a rear-facing camera, and FIG. 16B is a schematic diagram of the camera being used as a front-facing camera.

### DETAILED DESCRIPTION

Embodiments of the present invention will now be described with reference to the drawings. Hereafter, the components with the same function in different figures are given the same reference numerals, and will not be described repeatedly.

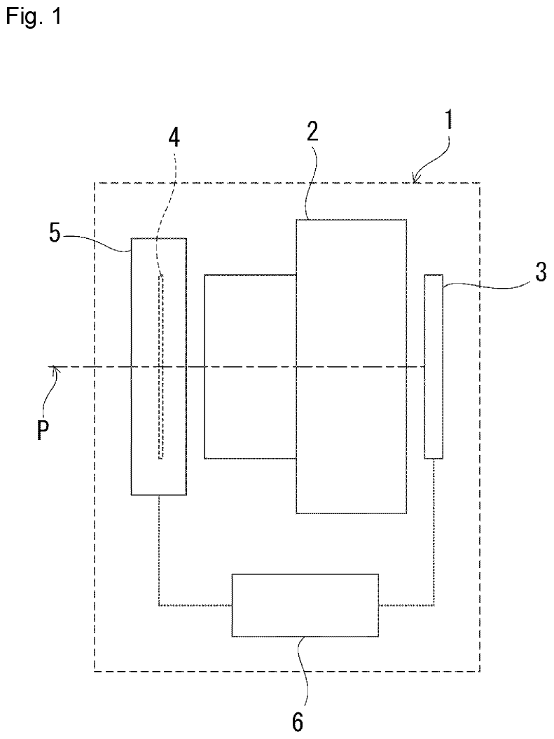

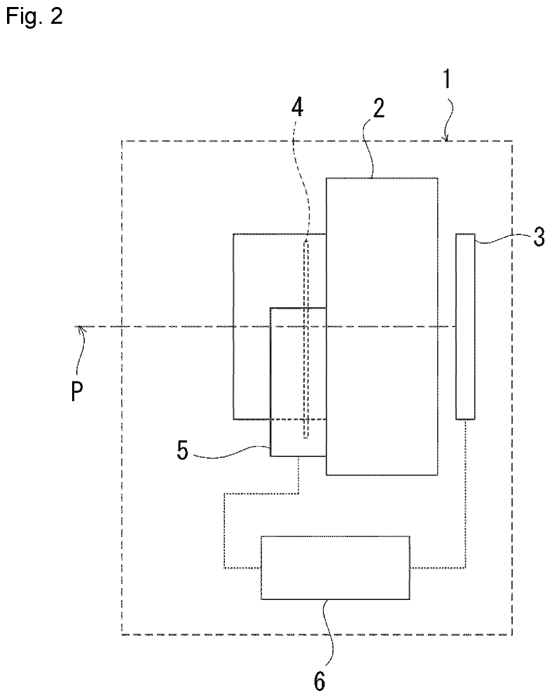

As shown in FIGS. 1 and 2, a camera 1 having, for example, a privacy protection function (hereafter, a camera) includes a lens barrel 2 as an imaging optical system for capturing an image of a subject, an image sensor 3 on which an image of the subject is formed through the lens barrel 2, a blade 4 that advances into an optical axis P of the lens barrel 2 as the imaging optical system, and a blade driver 5 that drives the blade 4 to advance into and retract from the optical axis P. The camera 1 also includes a controller 6 that controls driving of the blade driver 5 and the image sensor 3.

In an example structure shown in FIG. 1, the blade 4 and the blade driver 5 are located in front of the lens barrel 2. In an example structure shown in FIG. 2, the blade 4 is located between lenses in the lens barrel 2, and the blade driver 5 is located to surround a part of the lens barrel 2.

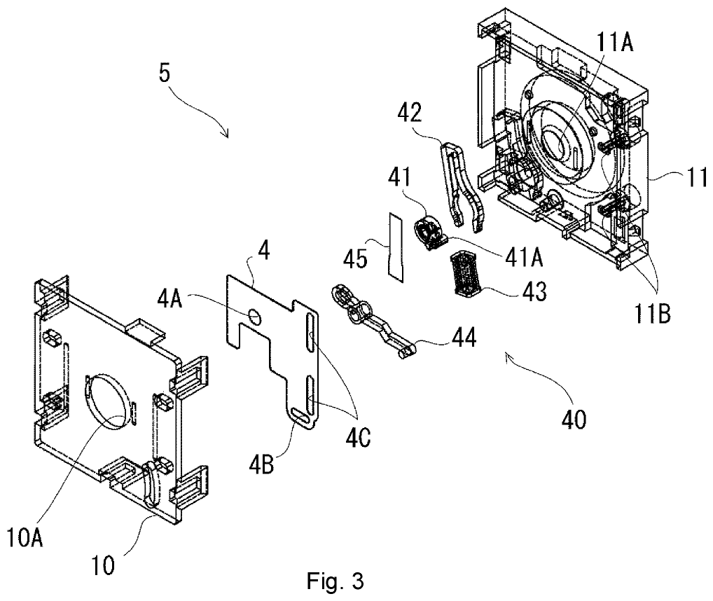

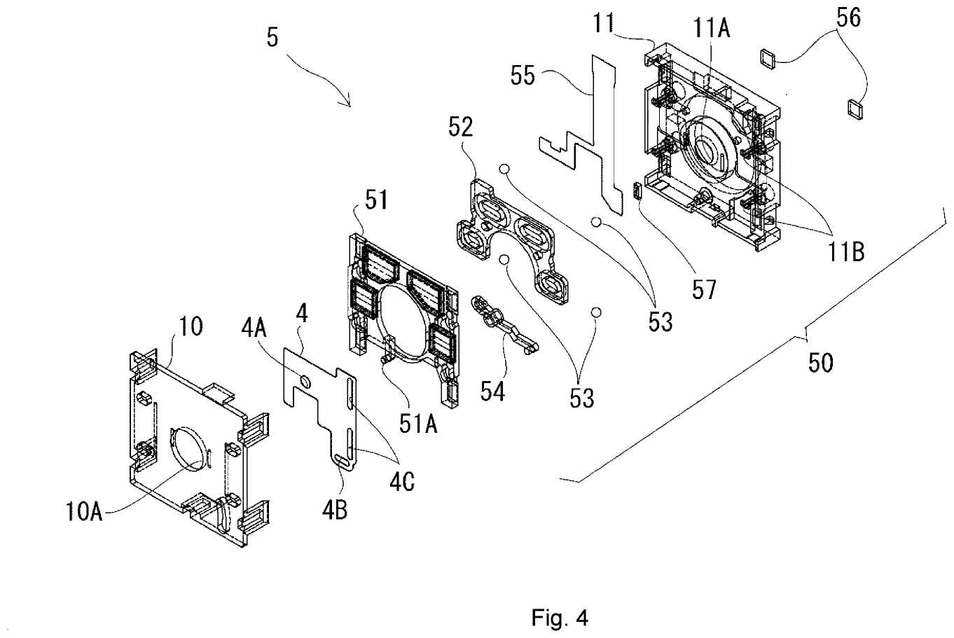

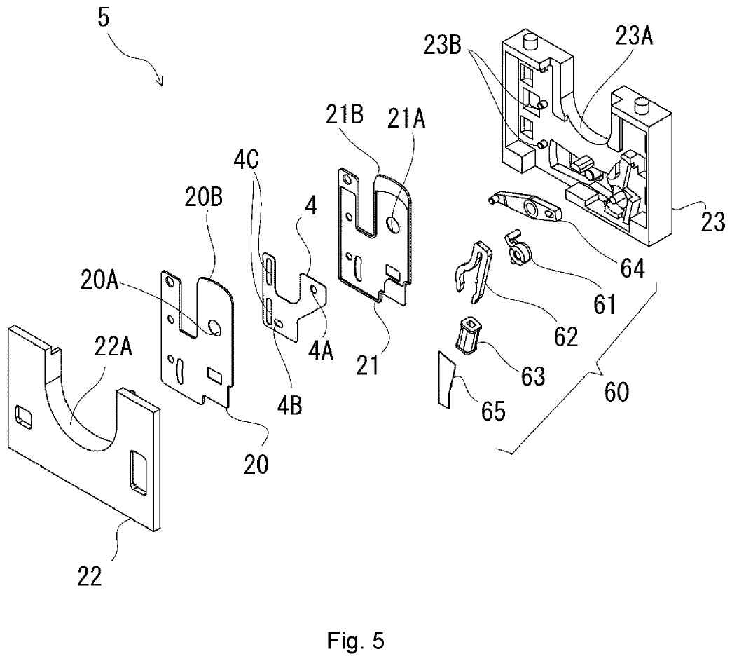

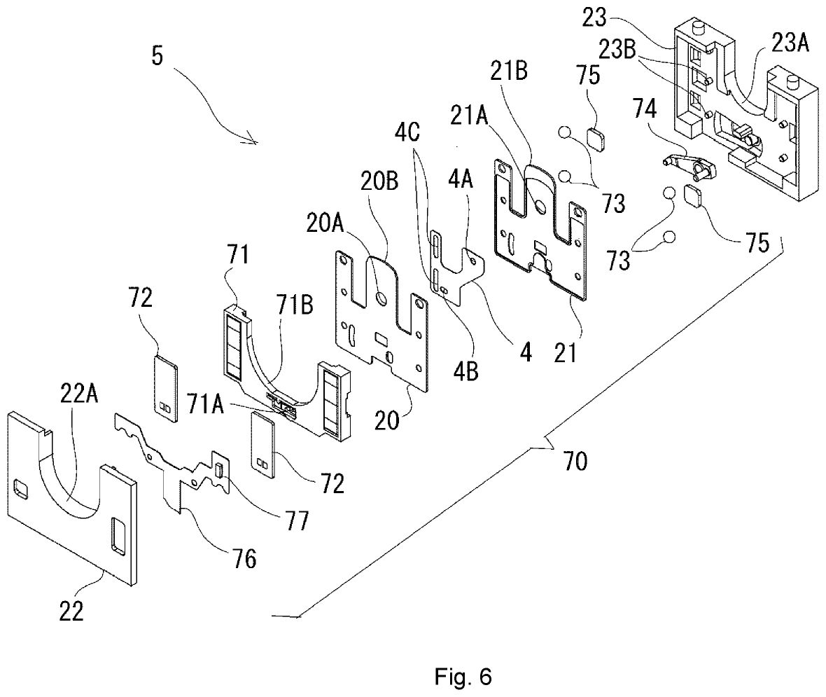

FIGS. 3 to 6 are diagrams showing example structures of the blade driver 5 in detail. In the example structures shown in FIGS. 3 and 4, the blade driver 5 is located in front of the lens barrel 2 as in the structure shown in FIG. 1. In the example structures shown in FIGS. 5 and 6, the blade driver 5 includes the blade 4 located between lenses in the lens barrel 2 as in the structure shown in FIG. 2.

The structure shown in FIG. 3 includes a front frame 10 having a front opening 10A coaxial with the optical axis P and a rear frame 11 having a rear opening 11A coaxial with the optical axis P. The blade 4 and a drive unit 40 that drives the blade 4 are accommodated between the front frame 10 and the rear frame 11. The blade 4 includes a blade portion 4A for causing privacy-related information to be less recognizable. The blade portion 4A is driven by the drive unit 40 to switch between a position advancing into the optical axis P of the lens barrel 2 and a position retracting from the optical axis P.

The drive unit 40 includes a rotor magnet 41 axially supported on the rear frame 11, a U-shaped yoke 42 located to surround the rotor magnet 41, a coil 43 wound around a part of the yoke 42, and a lever 44 having an intermediate member axially supported on the rear frame 11, one end connected with a connector 41A included in the rotor magnet 41, and the other end connected through a long hole 4B in the blade 4. In the drive unit 40, the coil 43 is energized through a flexible board 45 to rotate the rotor magnet 41. This swings the lever 44 to move the blade 4 along guide holes 4C. The guide holes 4C in the blade 4 receive guide protrusions 11B on the rear frame 11.

The structure shown in FIG. 4 includes the blade 4 and a drive unit 50 that drives the blade 4 located between the front frame 10 and the rear frame 11. In the same manner as in the example structure shown in FIG. 3, the drive unit 50 drives the blade portion 4A to switch between a position advancing into the optical axis P of the lens barrel 2 and a position retracting from the optical axis P.

The drive unit 50 includes a plate-like magnet support frame 51 supported on the rear frame 11 with bearings 53 in a manner movable uniaxially, a coil holder 52 holding a coil on the rear frame 11, a lever 54 having one end connected with a connector 51A included in the magnet support frame 51 and the other end connected through the long hole 4B in the blade 4, magnetic members 56 located on a back surface of the rear frame 11, and a Hall sensor 57 mounted on a flexible board 55. In the drive unit 50, a coil held by the coil holder 52 is energized through the flexible board 55 to reciprocate the magnet support frame 51 uniaxially. This swings the lever 54 to move the blade 4 along the guide holes 4C.

The structure shown in FIG. 5 includes a blade container 20 having an opening 20A coaxial with the optical axis P, and a blade container 21 having an opening 21A coaxial with the optical axis P. The blade 4 is movably accommodated in a thin space between the blade containers 20 and 21. The opening 20A in the blade container 20 is coaxial with the opening 21A in the blade container 21. To have the openings 20A and 21A between lenses, the blade containers 20 and 21 include protrusions 20B and 21B.

The blade containers 20 and 21, which accommodate the blade 4, and a drive unit 60 are accommodated between a front frame 22 and a rear frame 23. The front frame 22 has a recess 22A and the rear frame 23 has a recess 23A to partly surround the lens barrel 2. The protrusions 20B and 21B on the blade containers 20 and 21 protrude in the respective recesses 22A and 23A.

As in the example structure shown in FIG. 3, the drive unit 60 includes a rotor magnet 61, a yoke 62, a coil 63, and a lever 64. In the drive unit 60, the coil 63 is energized through a flexible board 65 to rotate the rotor magnet 61. This swings the lever 64 to move the blade 4 accommodated between the blade containers 20 and 21 along the guide holes 4C. The guide holes 4C in the blade 4 receive guide protrusions 23B on the rear frame 23.

The example structure shown in FIG. 6 includes the front frame 22 and the rear frame 23 accommodating the blade containers 20 and 21 accommodating the blade 4, and a drive unit 70 between them. The drive unit 70 drives the blade portion 4A to switch between a position advancing into the optical axis P of the lens barrel 2 and a position retracting from the optical axis P.

The drive unit 70 includes a plate-like magnet support frame 71 supported on the rear frame 23 with bearings 73 in a manner movable uniaxially, a coil 72 held on the front frame 22, a lever 74 having one end connected with a connector 71A included in the magnet support frame 71 and the other end connected through the long hole 4B in the blade 4, magnetic members 75, and a Hall sensor 77 mounted on a flexible board 76. The magnet support frame 71 has a recess 71B corresponding to the recesses 22A and 23A. In the drive unit 70, the coil 72 is energized through the flexible board 76 to reciprocate the magnet support frame 71 uniaxially. This swings the lever 74 to move the blade 4 along the guide holes 4C.

The blade driver 5 described above drives the blade portion 4A included in the blade 4 to advance into the optical axis P of the imaging optical system. The blade portion 4A partially has, for example, a light shield that causes privacy-related information about a subject to be less recognizable. To shield a privacy-related image completely, the entire blade portion 4A may be formed from a light shield.

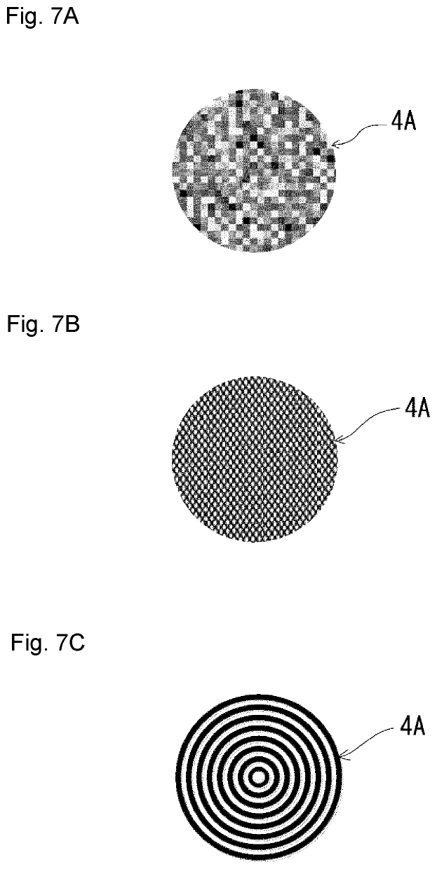

For example, the blade portion 4A may partially have a light shield with a mosaic as shown in FIG. 7A. In this example, the blade portion 4A is divided into multiple rectangular sections for which color densities and transmitted light amounts are randomly set to form a light shield with a mosaic. In the example structure shown in FIG. 7B, the blade portion 4A partially has a light shield with a mesh. In the example structure shown in FIG. 7C, the blade portion 4A partially has a light shield with a concentric circle pattern. The blade portion 4A may partially have a light shield with a spiral or vertical or horizontal stripes, without being limited to the examples described above.

The blade portion 4A partially having a light shield advances into the optical axis P to cause the image sensor 3 to capture an image missing detailed information, causing detailed states such as the faces of individuals and the details of a private space to be less recognizable. However, the image sensor 3 outputs a blurred image as image information indicating the presence or movement of a person or a rough state of a private space. This allows an image for monitoring a subject to be output while protecting privacy.

The blade portion 4A included in the blade 4 may be colored to cause privacy-related information about a subject to be less recognizable. In particular, red effectively lowers recognition of a skin-colored face image. When an image of a private space is captured, the same color as the background color of the space may be selected to cause privacy-related information to be less recognizable.

The blade portion 4A in the blade 4 may be easily visible to a subject to allow the subject to notice the blade portion 4A advancing into the optical axis P. More specifically, the surface of the blade portion 4A facing a subject may be colored with a highly visible color. As described above, the blade portion 4A may be red, which is a conspicuous color, to effectively allow a subject to notice that private information is protected.

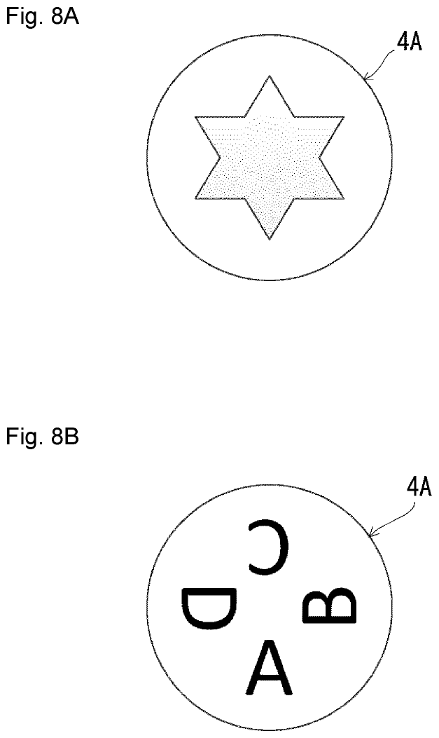

Also, the surface of the blade portion 4A facing a subject may be colored with a fluorescent color or have luster visible to a subject to allow the subject to visually notice that privacy is protected by the blade 4. The blade 4 may be located in front of the imaging optical system as in the example structure shown in FIG. 1 to allow a subject to more easily notice the blade 4 advancing into the optical axis P. As shown in FIGS. 8A and 8B, the surface of the blade portion 4A facing a subject may have a conspicuous mark or characters to further improve visibility.

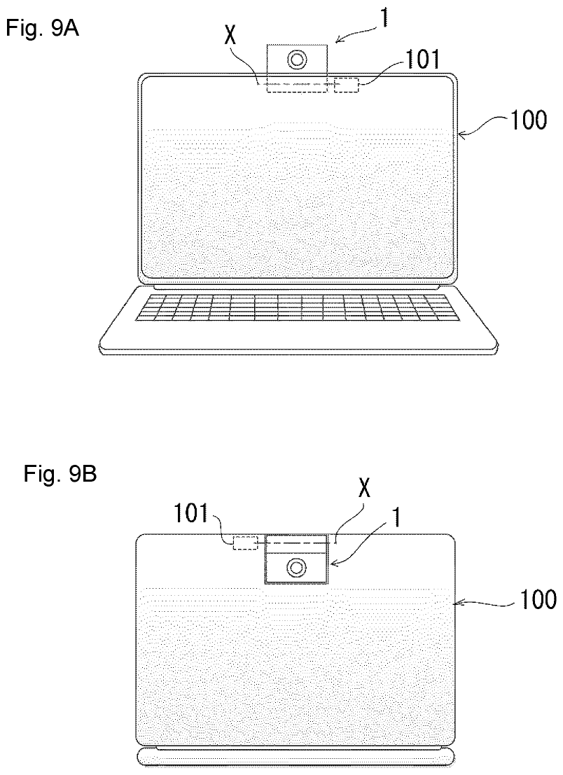

FIGS. 9A and 9B show a laptop personal computer (PC) as an example of an electronic device 100 including the camera 1. The electronic device 100 can switch the orientation of the camera 1 between facing in the same direction as the display surface (refer to FIG. 9A) and facing in the same direction as the back of the display surface (refer to FIG. 9B). The orientation of the camera 1 is switched in the manner described above by a drive motor 101. The drive motor 101 is rotated to rotate the housing of the camera 1 about a rotational shaft X to switch the camera 1 between the state shown in FIG. 9A and the state shown in FIG. 9B.

In the state shown in FIG. 9A, the electronic device 100 may be used to intentionally capture an image of a user's face (a privacy-related image) during, for example, an internet telephone call. In this case, the blade 4 in the camera 1 retracts from the optical axis P to allow a clear privacy-related image to be captured. In the state shown in FIG. 9B, the electronic device 100 with the camera 1 facing in the same direction as the back of the display surface may be used to obtain an image of a private space. In this case, the blade 4 in the camera 1 advances into the optical axis P to cause privacy-related information to be less recognizable.

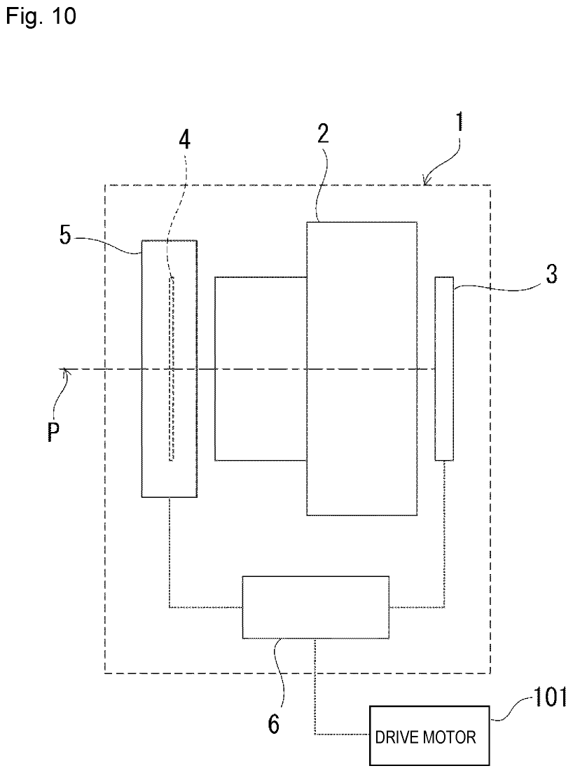

These operations may be interrelated by, for example, the controller 6 controlling driving of the blade driver 5 and the drive motor 101 as shown in FIG. 10. When the drive motor 101 is operated to orient the camera 1 in the same direction as the display surface, the blade 4 retracts from the optical axis P. When the drive motor 101 is operated to orient the camera 1 in the same direction as the back of the display surface, the blade 4 is controlled to advance into the optical axis P.

When a user intentionally captures a privacy-related image during, for example, an internet telephone call, the electronic device 100 in the state shown in FIG. 9A obtains a clear image and transmits the image through a network. When the electronic device 100 is switched to the state shown in FIG. 9B for obtaining a monitoring image, for example, to capture an image of a living state of a user, the blade 4 advances into the optical axis P of the imaging optical system to obtain an image with which privacy-related information is less recognizable and the image is then transmitted through a network.

When the electronic device 100 is in the state for obtaining a monitoring image, the controller 6 reliably causes the blade 4 to advance into the optical axis P, causing an image without privacy-related information to be transmitted while maintaining the monitoring function. This structure reduces leakage of privacy-related information when an image leaks due to, for example, malicious hacking. When the electronic device 100 is in the state for obtaining a monitoring image, a user directly views the blade 4 advancing into the optical axis P and notices that privacy is protected. This eliminates the user's worry about a possible invasion of privacy.

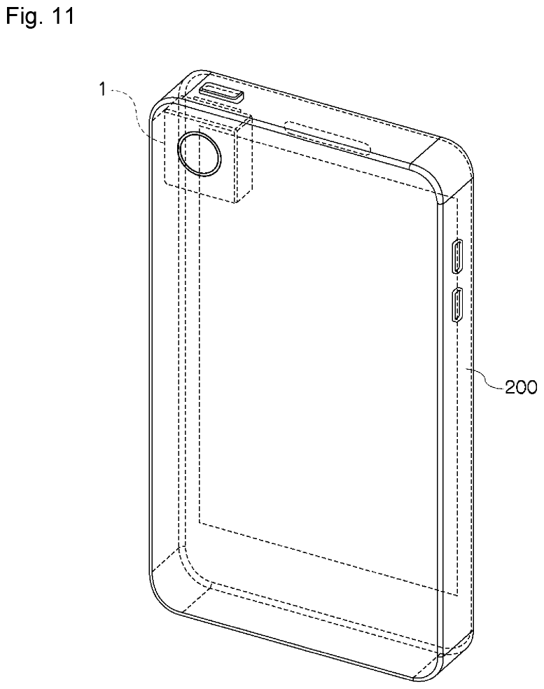

FIG. 11 shows a mobile information terminal such as a smartphone as an example of an electronic device 200 including the camera 1 described above. The camera 1 may be incorporated in the electronic device 200, which is a mobile information terminal.

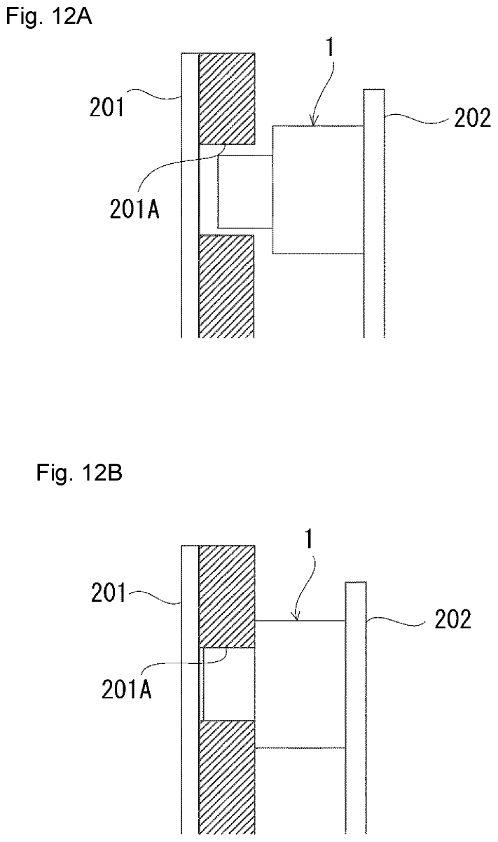

With a known technique, the camera 1 incorporated in the electronic device 200 such as a mobile information terminal is attached to, for example, an internal substrate 202 as shown in FIG. 12A, instead of being fixed to, for example, a front panel 201. In this case, a lens opening 201A in the front panel 201 is designed to have a dimension greater than the diameter of the lens of the camera 1 to absorb an alignment error of the camera 1. When the lens opening 201A is viewed from outside, a portion of the camera 1 other than its lens may be seen through the lens opening 201A, possibly degrading the appearance.

In response to this, as shown in FIG. 12B, the lens of the camera 1 is attached to the front panel 201 to close the lens opening 201A. This reduces misalignment between the centers of the lens opening 201A and the lens of the camera 1. Also, the closed lens opening 201A hides portions around the lens of the camera 1, thus improving the appearance. Moreover, the camera 1 in contact with the front panel 201 improves space efficiency in the electronic device 200. This reduces interference between the camera 1 and other components in the electronic device 200, thus increasing internal design variations for the electronic device 200.

When the camera 1 is incorporated in the electronic device 200 such as a mobile information terminal, the housing of the camera 1 or the housing of the blade driver included in the camera 1 interferes, at its corner, with a rounded portion of an edge of the electronic device 200. The camera 1 cannot be placed nearer the edge of the electronic device 200.

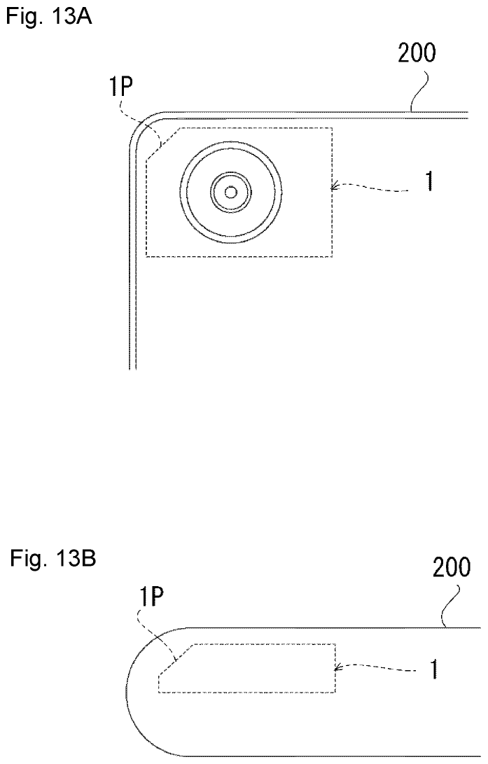

In response to this, as shown in FIGS. 13A and 13B, the housing of the camera 1 or the housing of the blade driver included in the camera 1 includes a chamfered corner 1P corresponding to the rounded edge of the electronic device 200. The chamfered corner 1P cannot be formed in a part of the housing of the blade driver containing an actuator. The chamfered corner 1P is thus formed in a part without the actuator. The chamfered corner 1P is then placed near the edge of the electronic device 200. In this manner, the camera 1 including a blade driver may be placed nearer the rounded edge of the electronic device 200. The camera 1 may thus be more flexibly placed in the electronic device 200.

When the camera 1 incorporated in the electronic device 200 such as a mobile information terminal includes a blade driver placed, for example, near a speaker, an actuator included in the blade driver and a magnet or a magnetic member included in the speaker may affect each other and may cause unstable operations of the blade driver and the speaker.

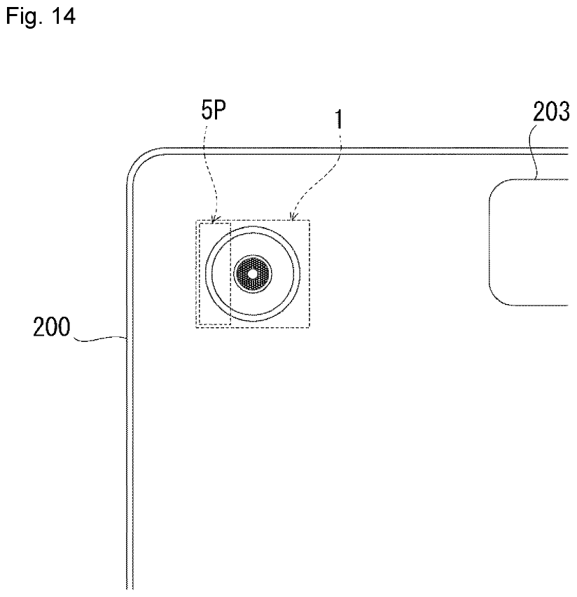

In response to this, as shown in FIG. 14, the camera 1 is placed to cause an actuator 5P in the blade driver to be away from a speaker 203 or a similar component in the electronic device 200. This structure prevents magnetic interference between the speaker 203 or a similar component and the blade driver included in the camera 1 without incorporating, for example, a magnetic shield, thus allowing stable operations of the camera 1 and the speaker 203 or a similar component.

The electronic device 200 such as a smartphone nowadays may incorporate a rear-facing camera for capturing landscape images and a front-facing camera for capturing self-portrait images. Incorporating two different cameras for different uses may increase the cost of the electronic device 200.

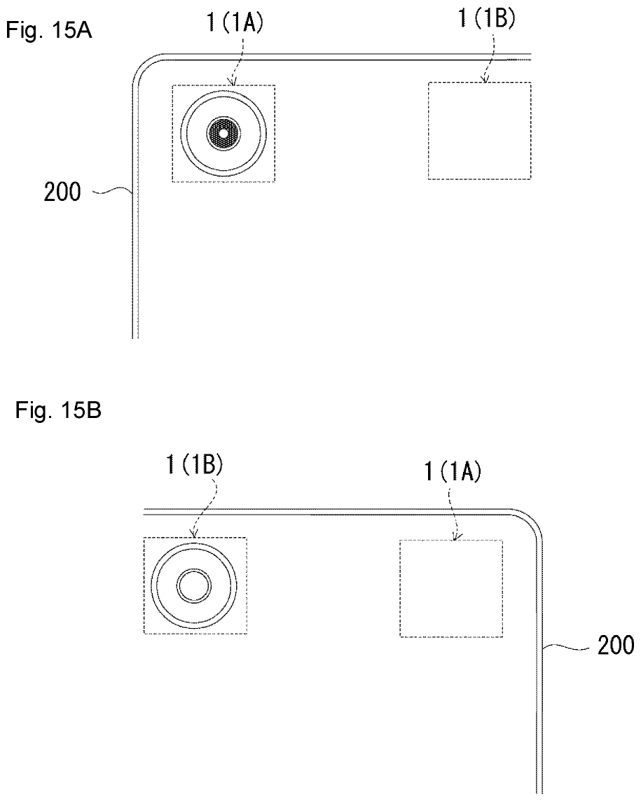

In response to this, as shown in FIGS. 15A and 15B, two identical cameras 1 each including a blade driver are incorporated as a rear-facing camera 1 (1A) and a front-facing camera 1 (1B). The rear-facing camera 1 (1A) has an aperture in the blade driver set by default for capturing landscape images (small aperture). The front-facing camera 1 (1B) has an aperture in the blade driver set by default for capturing self-portrait images (widest aperture). This structure may include identical cameras 1 to be the rear-facing camera 1 (1A) and the front-facing camera 1 (1B), reducing the part procurement cost and the development cost. One of the two incorporated cameras 1 may be set by default to have the widest aperture in the blade driver, and the other may be set by default to have the inserted blade portion 4A protecting private information.

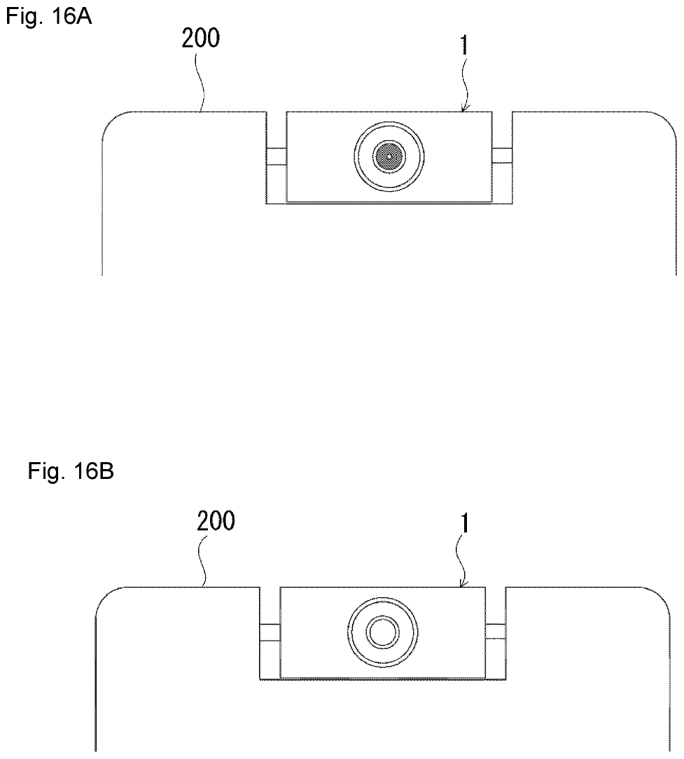

In the example structure shown in FIGS. 15A and 15B, one of the two cameras 1 includes the blade driver set by default for a rear-facing camera, and the other includes the blade driver set by default for a front-facing camera. However, as shown in FIGS. 16A and 16B, a single camera 1 may be used and may switch between the orientation for use as a front-facing camera and the orientation for use as a rear-facing camera. When the camera 1 is oriented for use as a rear-facing camera, the aperture in the blade driver may be set by default for capturing landscape images (small aperture) as shown in FIG. 16A. When the camera 1 is oriented for use as a front-facing camera, the aperture in the blade driver may be set by default for capturing self-portrait images (widest aperture) as shown in FIG. 16B. In this structure, the camera 1 may have, by default, the blade driver with the widest aperture for one use and the inserted blade portion 4A protecting private information for the other use.

As described above, the camera 1 according to the embodiments of the present invention includes the blade 4 advancing into the optical axis P of the imaging optical system to cause privacy-related information about a subject to be less recognizable. This structure thus allows the image sensor 3 to output image information excluding privacy-related information. This structure reduces leakage of privacy-related information when an image leaks due to, for example, malicious hacking.

Moreover, the blade 4 advancing into the imaging optical system is visible to a subject to allow the subject to notice that privacy is protected. This eliminates the subject's worry about a possible invasion of privacy.

Although the embodiments of the present invention have been described in detail with reference to the drawings, the specific structures are not limited to the above embodiments. The present invention may be modified in design without departing from the spirit and scope of the present invention. Additionally, the techniques described in the above embodiments may be combined, unless any contradiction arises in their purposes and structures.

What is claimed is:

1. A camera, comprising:
an imaging optical system configured to capture an image of a subject;
an image sensor;
a blade configured to advance into an optical axis of the imaging optical system; and
a blade driver configured to cause the blade to advance into and retract from the optical axis,
wherein the blade causes privacy-related information about a subject to be less recognizable.

2. The camera according to claim 1, wherein
the blade partially includes a light shield.

3. The camera according to claim 2, wherein
the light shield has a mosaic, a mesh, or a pattern.

4. The camera according to claim 1, wherein
the blade has a color that causes privacy-related information about a subject to be visually less recognizable.

5. The camera according to claim 1, wherein
the blade has a color visible to a subject.

6. The camera according to claim 5, wherein
the color is red.

7. The camera according to claim 5, wherein
the color is a fluorescent color.

8. The camera according to claim 1, wherein
the blade has luster visible to a subject.

9. The camera according to claim 1, wherein
the blade includes a character or a mark on a surface of the blade facing a subject.

10. The camera according to claim 1, wherein
the blade is located in front of the imaging optical system.

11. A camera, comprising:
an imaging optical system configured to capture an image of a subject;
an image sensor;
a blade configured to advance into an optical axis of the imaging optical system; and
a blade driver configured to cause the blade to advance into and retract from the optical axis,
wherein the blade includes a character or a mark on a surface of the blade facing a subject.

12. An electronic device, comprising:
the camera according to claim 1.
